(19) United States
(12) Patent Application Publication
(10) Pub. No.: US 2026/0077378 A1
(43) Pub. Date: Mar. 19, 2026

(54) SLOT DIE COATER

(71) Applicant: SAMSUNG SDI CO., LTD., Yongin-si (KR)

(72) Inventor: Kichoon LEE, Yongin-si (KR)

(21) Appl. No.: 19/275,079

(22) Filed: Jul. 21, 2025

(30) Foreign Application Priority Data
Sep. 13, 2024 (KR) 10-2024-0126127

(51) Int. Cl. B05C 5/02; H01M 4/04

(52) U.S. Cl. CPC B05C 5/0254; H01M 4/0404

(57) ABSTRACT

A slot die coater includes a lower die, an upper die disposed above the lower die and coupled to the lower die, and a shim member disposed between the lower die and the upper die and forming a plurality of discharge ports in a width direction. The lower die includes an injection port through which a slurry can be introduced into the slot die coater, a cavity configured to increase the slurry introduced through the injection port in the width direction and cause the slurry to flow through the discharge ports, and an extension portion that connects the injection port and the cavity and is configured to cause the slurry to expand in the width direction from the injection port to the cavity.

### CROSS-REFERENCE TO RELATED APPLICATION

This application claims priority to and the benefit of Korean Patent Application No. 10-2024-0126127 filed in the Korean Intellectual Property Office on September 13, 2024, the entire contents of which are incorporated herein by reference.

### BACKGROUND OF THE DISCLOSURE

### (a) Field of the Invention

The present disclosure relates to a slot die coater that may coat an electrode substrate.

### (b) Description of the Related Art

A rechargeable battery is a battery that performs repeated charging and discharging. Small-capacity rechargeable batteries are used in a portable small electronic device such as mobile phones, laptop computers, and camcorders. Large-capacity and high-density rechargeable batteries are used for a power source or energy storage for driving a motor of hybrid and electric vehicles.

A rechargeable battery includes an electrode assembly for charging and discharging current, a case or pouch accommodating the electrode assembly and an electrolyte, and an electrode terminal connected to the electrode assembly and drawn out of the case or pouch. The electrode assembly may be formed as a jelly roll type by winding electrodes and a separator or as a stack type formed by stacking electrodes and a separator.

The manufacturing process of a rechargeable battery includes the process of manufacturing the electrode. An electrode manufacturing process uses a slot die coater to coat an active material slurry on an electrode plate substrate. In a typical slot die coater, the slurry injection port is disposed at a center of a width direction. Thus, the slurry flow rate is high in the central region of the cavity, and the slurry flow rate is relatively low at both side regions of the cavity, which increases the residence time of the slurry. When the cavity is wide, the slurry residence time increases further.

The difference in slurry flow rate and the increase in slurry residence time cause a deviation in the width direction loading level, which makes the loading level in the side region of the cavity lower than the loading level in the center of the cavity when coating the active material slurry. Additionally, the increase in slurry residence time in the side region of the cavity causes stagnation and coagulation of the slurry.

### SUMMARY OF THE DISCLOSURE

An object of the present disclosure is to provide a slot die coater that prevents slurry stagnation and agglomeration by minimizing an increase in slurry residence time in a side region of a wide cavity. Another object of the present disclosure provides a slot die coater that prevents changes in slurry properties by preventing slurry stagnation and slurry agglomeration.

An embodiment of the present disclosure provides a slot die coater including: a lower die, an upper die disposed above the lower die and coupled to the lower die, and a shim member disposed between the lower die and the upper die and forming plurality of discharge ports in a width direction, wherein the lower die includes an injection port through which a slurry can be introduced into the slot die coater, a cavity configured to increase the slurry introduced through the injection port in the width direction and cause the slurry to flow through the discharge ports, and an extension portion that connects the injection port and the cavity and is configured to cause the slurry to increase.

The injection port may be positioned to correspond to a central discharge port positioned at a center in the width direction among the discharge ports.

The extension portion may extend an equal distance from the central discharge port to both sides in the width direction.

The extension portion may extend longer than a width of the central discharge port.

The extension portion extends from the central discharge port to the discharge ports provided adjacent to both sides of the central discharge port in the width direction.

The extension portion may be symmetrical with respect to the central discharge port and discharge ports disposed on both sides in the width direction, and the number of discharge ports provided at both ends in the width direction may be less than the number of discharge ports connected to the extension portion.

The extension portion may include a curved surface that is connected to the injection port and a straight surface that is connected to the curved surface.

The curved surface may be formed at an angle less than 90 degrees, and the straight surface extends along a tangent to the curved surface.

In the width direction, a width of the curved surface may be shorter than a width of the straight surface.

In a discharge direction of the discharge ports through which the slurry is discharged, a length of the curved surface may be shorter than a length of the straight surface.

A sum of the length of the curved surface and the length of the straight surface may be longer than a length of the injection port.

The extension portion may be such that, in a discharge direction of the discharge ports from which the slurry is discharged, a first deceleration amount of a flow rate of the slurry by the curved surface may be greater than a second deceleration amount of the flow rate of the slurry by the straight surface.

The extension portion may form an end of the injection port at a portion connected to the cavity, and the end of the injection port may be formed to extend in the width direction with a set height.

According to the embodiments of the present disclosure, an injection port and a cavity of a slot die coater are connected to each other with an extension portion to allow slurry to increase and flow in the width direction at it is introduced from the injection port to the cavity, thereby minimizing the increase in the slurry residence time in the side region of the wide cavity. Thus, it is possible to prevent slurry stagnation and slurry agglomeration and also to prevent changes in the slurry properties.

### BRIEF DESCRIPTION OF THE DRAWINGS

FIG. 1 is a cross-sectional view of a slot die coater according to an embodiment of the present disclosure.

FIG. 2 is a plan view of a shim member applied to FIG. 1.

FIG. 3 is a perspective view of a lower die having a cavity applied to FIG. 1.

FIG. 4 is a top plan view of a cavity applied to FIG. 1.

FIG. 5 is a partial detailed view of a cavity injection port of FIG. 1.

FIG. 6 is an image of simulating a residence time of slurry inside a cavity when a cavity injection port according to the prior art is used.

FIG. 7 is an image of simulating a residence time of slurry inside a cavity when a cavity injection port according to an embodiment of the present disclosure is used.

### DETAILED DESCRIPTION OF THE EMBODIMENTS

The present disclosure will be described more fully hereinafter with reference to the accompanying drawings, in which embodiments of the disclosure are shown. As those skilled in the art would realize, the described embodiments may be modified in various different ways without departing from the spirit or scope of the present disclosure. The drawings and description are to be regarded as illustrative in nature and not restrictive. Like reference numerals designate like elements throughout the specification.

Terms including an ordinal number, such as first, second, etc., may be used to describe various elements, but the elements are not limited by the terms. These terms are only used to differentiate one constituent element from another.

It should be understood that when an element is described as “coupled” or “connected” to another element, the element may be “directly coupled” or “directly connected” to the other element, or may be “coupled” or “connected” to the other element through a third element. In contrast, it should be understood that when an element is described as “directly coupled” or “directly connected” to another element, no element is present between the element and the other element.

Throughout the specification, it should be understood that the term “include”, “comprise”, “have”, or “configure” indicates that a feature, a number, a step, an operation, a constituent element, a part, or a combination thereof described in the specification is present, but does not exclude a possibility of presence or addition of one or more other features, numbers, steps, operations, constituent elements, parts, or combinations, in advance. Unless explicitly described to the contrary, the word “comprise” and variations such as “comprises” or “comprising” will be understood to imply the inclusion of stated elements but not the exclusion of any other elements.

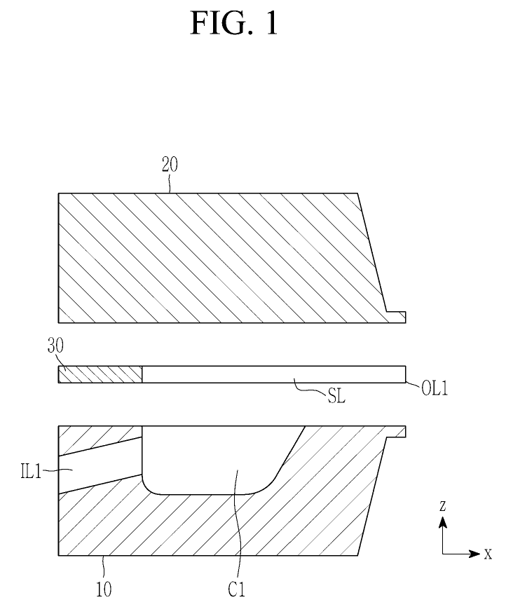

FIG. 1 is a cross-sectional view of a slot die coater according to an embodiment of the present disclosure. A slot die coater according to an embodiment includes a lower die 10, an upper die 20, and a shim member 30. The lower die 10 has a cavity C1 and an injection port IL1. The active material slurry from outside is supplied to the cavity C1 through the injection port IL1 of the lower die 10. The upper die 20 is coupled to the upper lower die 10 with the shim member 30 interposed therebetween.

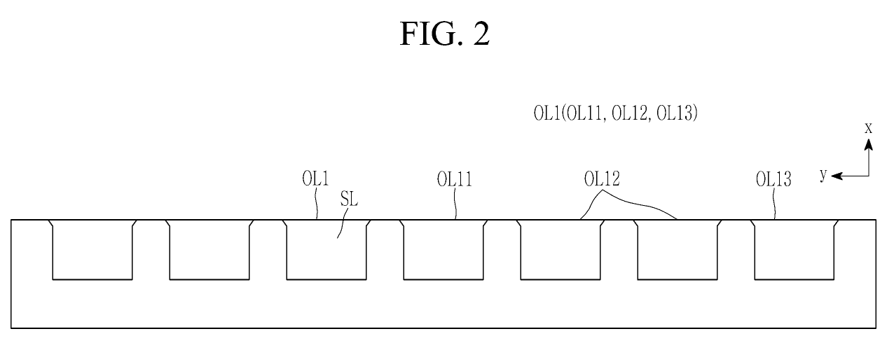

FIG. 2 is a plan view of a shim member as used in the slot die coater depicted in FIG. 1. Referring to FIG. 1 and FIG. 2, the shim member 30 has a thickness and is interposed between the lower die 10 and the upper die 20 to set a slot SL and a discharge port OL1 for discharging an active material slurry.

The shim member 30 includes a plurality of discharge ports OL1. The active material slurry is discharged through the discharge ports OL1 of the shim member 30 to form a plurality of active material coating portions on the electrode substrate.

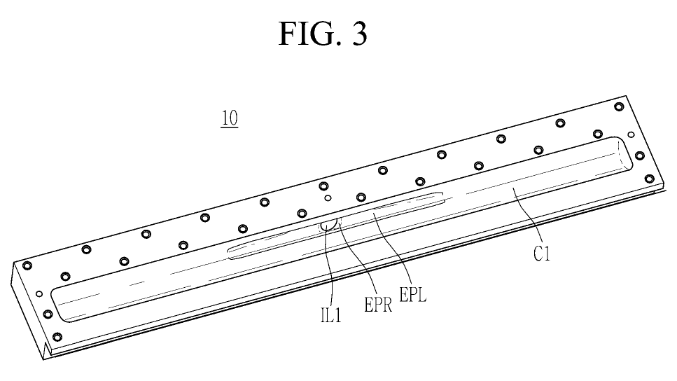

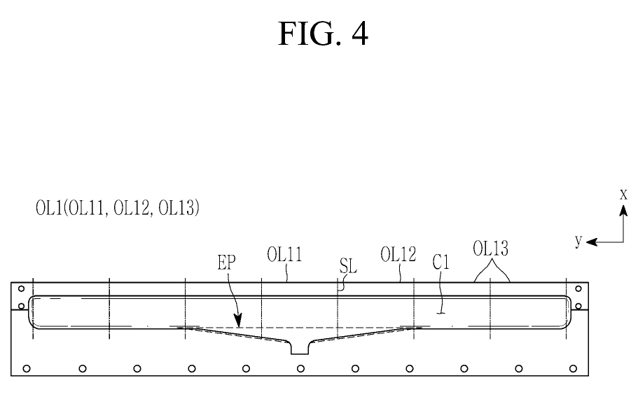

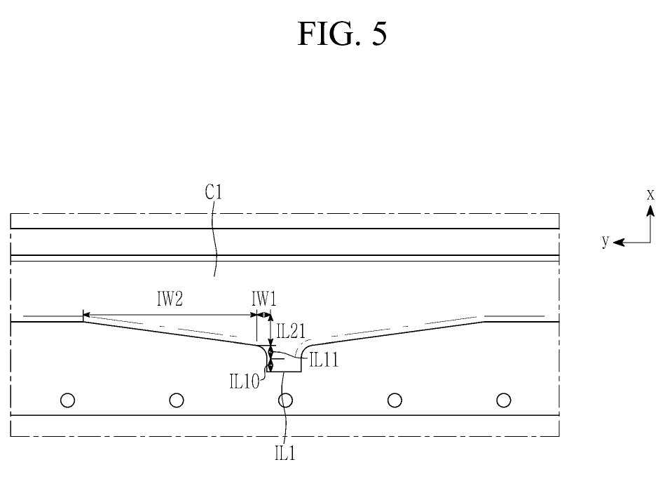

FIG. 3 is a perspective view of a lower die having a cavity as in the slot die coater depicted in FIG. 1, FIG. 4 is a top plan view of the cavity, and FIG. 5 is a partial detailed view of the cavity injection port.

Referring to FIGS. 3 to 5, the lower die 10 includes an injection port IL1, a discharge port OL1, a cavity C1, and an extension portion EP.

The cavity C1 increases the active material slurry that is injected into the injection port IL1 in the width direction (y-axis direction) so as to allow the active material slurry to flow through the discharge ports OL1. The cavity C1 is formed the same cross-sectional shape in the discharge direction (x-axis direction) throughout the width direction. In an example, the cavity C1 includes a uniform groove structure in the x-axis direction. Therefore, the cavity C1 is connected to the same cross-section structure to a plurality of slots SL and discharge ports OL1.

The extension portion EP connects the injection port IL1 and the cavity C1, so that an increased amount of active material slurry flows in the width direction (y-axis direction) from the injection port IL1 to the cavity C1. For example, the extension portion EP increases a cross-sectional area of the active material slurry introduced through the injection port IL1 to connect a wide cross-sectional area to the cavity C1. Therefore, the cross-sectional area of the active material slurry gradually increases as it passes through the extension portion EP from the injection port IL1.

Since the extension portion EP extends from the injection port IL1 to both side regions in the width direction (y-axis direction), the flow rate of the slurry decreases as the cross-sectional area of the injection port IL1 increases. The active material slurry injected into the extension portion EP moves to both side regions of the width direction (y-axis direction) of the cavity C1 along the extended inclined surface.

Thus, the residence time of the active material slurry in both side regions of the cavity C1 may be reduced. In other words, stagnation of the active material slurry and agglomeration of the active material slurry may be prevented in both side regions of the cavity C1, thereby preventing changes in physical properties of the active material slurry.

Regarding the injection port IL1 and the extension portion EP, the injection port IL1 is disposed to correspond to the central discharge port OL11 disposed at the center in the width direction (y-axis direction) among the discharge ports OL1. That is, the injection port IL1 is aligned with the center of the cavity C1 in the width direction (y-axis direction) to supply the active material slurry equally to both sides in the width direction.

The extension portion EP is formed by extending with the same length on both sides in the width direction (y-axis direction) from the central discharge port OL11. The extension portion EP extends longer than the unit width of the central discharge port OL11. For example, the extension portion EP is formed by extending from the central discharge port OL11 to the discharge ports OL12 provided adjacent to both sides of the central discharge port OL11 based on the width direction (y-axis direction).

Thus, the active material slurry introduced through the injection port IL1 is not concentrated only on the central discharge port OL11, but is supplied to the adjacent discharge ports OL12 through the extension portion EP. That is, the active material slurry may be directly supplied to the central discharge port OL11 and also to the adjacent discharge port OL12 without passing through the cavity C1.

In addition, the extension portion EP is connected in a symmetrically relative to the central discharge port OL11 and the discharge ports OL12 disposed on both sides in the width direction (y-axis direction). Accordingly, the active material slurry may be symmetrically supplied to both sides of the cavity C1 in the width direction (y-axis direction). Thus, the flow rate of the active material slurry may be reduced at the center in the width direction (y-axis direction) and the flow rate is symmetrical at both sides in the width direction (y-axis direction).

The number of the discharge ports OL13 provided at both ends of the extension portion EP in the width direction (y-axis direction) may be less than the number of the discharge ports OL11 and OL12 connected to the extension portion EP. Therefore, the active material slurry may be supplied to each of the discharge ports OL13 as much as possible without passing through the cavity C1 to both sides of the cavity C1 in the width direction (y-axis direction). That is, relatively increased flow rate at the center of the cavity C1 is minimized, and relatively decreased flow rate at both ends thereof in the width direction (y-axis direction) is minimized.

The extension portion EP includes a curved portion (surface) EPR that is connected to the injection port IL1 in a curved line, and a straight portion (surface) EPL that is connected to the curved portion EPR in a straight line. The curved portion EPR is formed at an angle less than 90 degrees, and the straight portion EPL is connected tangent to the curved portion EPR. The angle of the curved portion may correspond to a central angle of an arc defined by both ends of the curved portion.

Based on the width direction (y-axis direction) of the discharge port OL1 through which the slurry is discharged, the injection width IW1 of the curved portion EPR is shorter than the injection width IW2 of the straight portion EPL (IW1<IW2). Based on the discharge direction (x-axis direction) of the discharge port OL1 through which the slurry flows, the injection length IL11 of the curved portion EPR is shorter than the injection length IL21 of the straight portion EPL (IL11<IL21).

The relationship (IW1<IW2) between the injection widths IW1 and IW2 and the relationship (IL11<IL21) between the injection lengths IL11 and IL21 may significantly reduce the flow rate of the active material slurry in the curved section EPR, thereby lowering the flow rate to the discharge port OL11 disposed in the center and minimize the decrease in the flow rates to the adjacent discharge ports OL12 and the discharge ports OL13. In other words, a difference in the flow rate of the active material slurry across all discharge ports OL1 is reduced.

The sum of the injection length IL11 of the curved portion EPR and the injection length IL21 of the straight portion EPL is longer than the injection length IL0 of the injection port IL1. Therefore, based on the discharge direction (x-axis direction) of the discharge port OL1 where the active material slurry is introduced through the injection port IL1 and passes through the injection length IL0, a first deceleration amount at which the flow rate of the slurry is gradually decelerated in the curved portion EPR is greater than a second deceleration amount at which the flow rate of the slurry is gradually decelerated in the straight portion EPL (first deceleration amount > second deceleration amount).

When the extension portion EP is cut in the discharge direction (x-axis direction) of the slurry, the maximum cross-sectional area of the passage is formed by the curved portion EPR, and the cross-sectional area of the passage is gradually reduced in the straight portion EPL. Therefore, the flow rate decreases to the maximum in the curved portion EPR, and the flow rate decreases little by little from the center to the outside in the straight portion EPL.

Based on the discharge direction (x-axis direction) of the discharge port OL1 where the active material slurry is introduced through the injection port IL1 and passed through the injection length IL0, the first deceleration amount at which the flow rate of the slurry is gradually decelerated in the curved portion EPR is greater than the second deceleration amount at which the flow rate of the slurry is gradually decelerated in the straight portion EPL (first deceleration amount > second deceleration amount).

The extension portion EP forms the final end of the injection port IL1 at a portion connected to the cavity C1, and the final end of the injection port IL1 has a set height and extends in the width direction (y-axis direction).

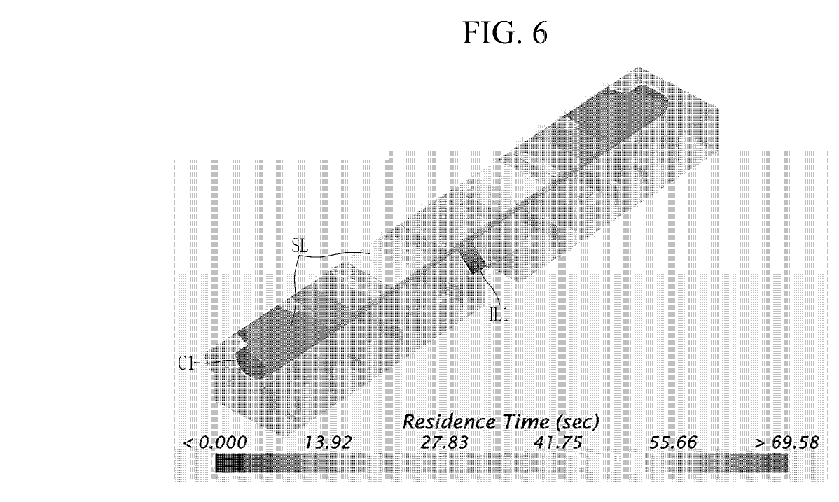

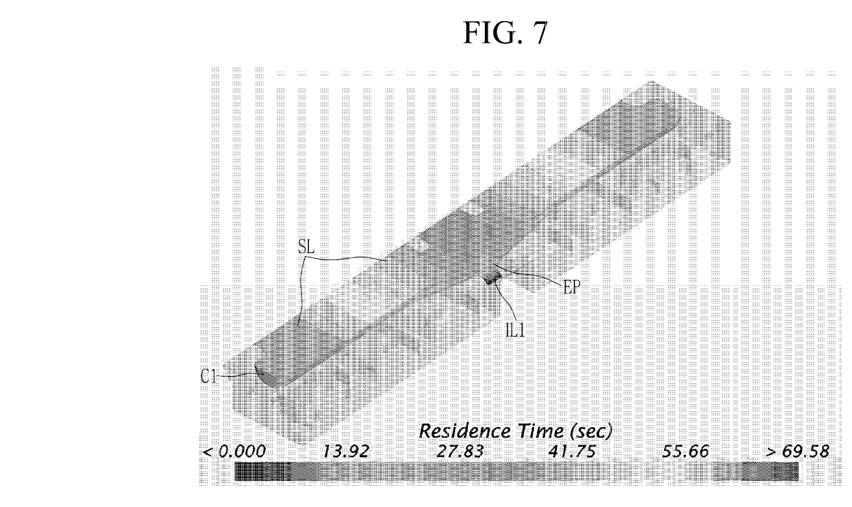

FIG. 6 is a result image of a simulation of a residence time of slurry inside a cavity including a cavity injection port according to prior art, and FIG. 7 is a result image of a simulation of a residence time of slurry inside a cavity including a cavity injection port according to an embodiment of the present disclosure.

Referring to FIG. 6, when the lower die was not provided with an extension portion, as in the prior art, the residence time of the active material slurry in the cavity C1 and the slot SL was found to be about 0.00 to 69.58 seconds. Referring to FIG. 7, when the extension portion EP is provided in the lower die 20 as in an embodiment of the present disclosure, the residence time of the active material slurry in the cavity C1 and the slot SL was about 0.00 to about 60.00 seconds.

Referring to FIG. 6 and FIG. 7, in an embodiment of the present disclosure having an extension portion EP, the residence time of the active material slurry in the cavity C1 and the slot SL showed a difference of up to about 9.58 seconds as compared to the prior art. As understood from this, the embodiment may prevent slurry stagnation and slurry agglomeration compared to the prior art by minimizing the increase in slurry residence time in the side region of the cavity C1. That is, an embodiment of the present disclosure may prevent changes in slurry properties by preventing stagnation of the slurry and agglomeration of the slurry.

While this disclosure has been described in connection with what is presently considered to be practical embodiments, it is to be understood that the disclosure is not limited to the disclosed embodiments. Rather, to the present disclosure covers various modifications and equivalent arrangements.

### DESCRIPTION OF SYMBOLS

10: upper die 20: lower die

30: shim member C1: cavity

EPR: curved portion EPL: straight portion

IL1: injection port OL1: discharge port

IL11: injection length IL21: injection length

IW1: injection width IW2: injection width

OL11: central discharge port OL12: discharge port

OL13: discharge port SL: slot

WHAT IS CLAIMED IS:

1. A slot die coater comprising:
a lower die;
an upper die disposed above the lower die and coupled to the lower die; and
a shim member disposed between the lower die and the upper die and forming a plurality of discharge ports in a width direction,
wherein the lower die includes:
an injection port through which a slurry can be introduced into the slot die coater,
a cavity configured to expand the slurry introduced through the injection port in the width direction and cause the slurry to flow through the discharge ports, and
an extension portion that connects the injection port and the cavity and is configured to cause the slurry to expand in the width direction and flow from the injection port to the cavity.

2. The slot die coater of claim 1, wherein the injection port is positioned to correspond to a central discharge port positioned at a center in the width direction among the discharge ports.

3. The slot die coater of claim 2, wherein the extension portion extends an equal distance from the central discharge port to both sides in the width direction.

4. The slot die coater of claim 2, wherein the extension portion extends longer than a width of the central discharge port.

5. The slot die coater of claim 4, wherein the extension portion extends from the central discharge port to the discharge ports provided adjacent to both sides of the central discharge port in the width direction.

6. The slot die coater of claim 5, wherein the extension portion is symmetrical with respect to the central discharge port and discharge ports disposed on both sides in the width direction, and
wherein the number of discharge ports provided at both ends in the width direction is less than the number of discharge ports connected to the extension portion.

7. The slot die coater of claim 2, wherein the extension portion includes a curved surface that is connected to the injection port and a straight surface that is connected to the curved surface.

8. The slot die coater of claim 7, wherein the curved surface is formed at an angle less than 90 degrees, and the straight surface extends along a tangent to the curved surface.

9. The slot die coater of claim 8, wherein, in the width direction, a width of the curved surface is shorter than a width of the straight surface.

10. The slot die coater of claim 8, wherein, in a discharge direction of the discharge ports through which the slurry is discharged,
a length of the curved surface is shorter than a length of the straight portion.

11. The slot die coater of claim 10, wherein a sum of the length of the curved surface and the length of the straight surface is longer than a length of the injection port.

12. The slot die coater of claim 8, wherein the extension portion is configured such that, in a discharge direction of the discharge ports from which the slurry is discharged, a first deceleration of a flow rate of the slurry by the curved surface is greater than a second deceleration of the flow rate of the slurry by the straight surface.

13. The slot die coater of claim 12, wherein a maximum cross-sectional area of the extension portion includes the curved surface, and a cross-sectional area of the extension portion gradually decreases in the discharge direction.

14. The slot die coater of claim 2, wherein the extension portion forms an end of the injection port at a portion connected to the cavity, and the end of the injection port is formed to extend in the width direction with a set height.

15. The slot die coater of claim 1, wherein the cavity has the same cross-sectional shape in a discharge direction of the discharge ports from which the slurry is discharged.
